(19) United States
(12) Patent Application Publication
(10) Pub. No.: US 2004/0140954 A1
(43) Pub. Date: Jul. 22, 2004

(54) Two handed computer input device

(76) Inventor: Michael Gene Faeth, Fresno, CA (US)

Correspondence Address: The Law Office of Craig W. Barber, PO Box 16220, Golden, CO, 80402-6004, US

(21) Appl. No.: 10/754,864

(22) Filed: Jan. 8, 2004

Related U.S. Application Data
(60) Provisional application No. 60/440,216, filed on Jan. 14, 2003.

(51) Int. Cl. G09G 5/08

(52) U.S. Cl. 345/163

(57) ABSTRACT

A computer input device has two modules, each module located at the natural resting position of one of the computer user's corresponding hands on a work surface. The first module has a pointing device, while the second module has a touch sensitive device such as a button. By this means, users who spend a great deal of time on the computer may easily input analog data by using one hand to point and the other hand to click, thus splitting up the point and click effort between two hands. Connections may be established wirelessly.

### CROSS-REFERENCE TO RELATED APPLICATIONS

This invention claims the priority and benefit of U.S. Provisional Patent Application No. 60/440,216 filed Jan. 14, 2003 in the name of the same inventor, Michael Faeth, and entitled “TWO HAND JOYSTICK INPUT DEVICE” and as disclosed in Disclosure Document No. 515675 dated Jul. 18, 2002 entitled “TWO-HAND JOYSTICK INPUT DEVICE” in the name of the same inventor, Michael Faeth.

### FIELD OF THE INVENTION

This invention relates generally to computer input devices and specifically to pointing devices such as mice and joysticks.

### STATEMENT REGARDING FEDERALLY FUNDED RESEARCH

This invention was not made under contract with an agency of the US Government, nor by any agency of the US Government.

### BACKGROUND OF THE INVENTION

“Point and Click” functions have become very important in computer use in the last two decades, due to widespread acceptance of graphical user interfaces (GUI) and mouse-oriented software programs. Unfortunately, of the existing devices that enable users to send commands relating to such mousing functions to a computer, almost all are designed to be used in a one-handed manner. The common desktop mouse is a perfect example of this: moving the mouse creates “point” commands in the computer, while pushing buttons on the mouse activate the “click” functions. The mouse field is over-run with virtually identical devices on this system. Many incorporate extra features (scroll wheels, extra buttons, advanced motion tracking systems and so on) but few devices get a way from the basic idea of “point and click” combined into a single device.

The problem with one handed mouse functions is that the ergonomic aspects of the one handed mouse are less than ideal. For example, a common mouse requires a user to move the arm, wrist, and hand for pointing while simultaneously sending click commands with the fingers. This continual one-handed mouse usage can actually contribute to a number of detrimental conditions. When the user engages in heavy mouse use, the user may be susceptible to developing discomfort, or worse: Carpal Tunnel Syndrome, Repetitive Motions syndrome, and so on, problems which may occur in the hand, wrist, arm or elbow of the user. Certain types of programs in particular are more likely to cause these problems: computer generated graphics art, games, audio editing software and certain other mouse-oriented software programs may exacerbate this problem. Also, quite a large space must be set aside for the mouse as it is moved around the desktop for pointing functions.

There are also accessibility issues related to mice, and various attempts which have been made to address such issues. For individuals with certain conditions or problems which make motion painful or reduce coordination, execution of both point and click functions on one hand may be exceedingly difficult or impossible.

US Patent Pub. No. 2002/0175894 dated Nov. 28, 2002 to Grillo entitled Hand Supported Mouse for Computer Input is one of the numerous “variation” type devices which seem to have little structure which could be used to oppose patentability on this invention. U.S. Pat. No. 6,545,664 dated Apr. 8, 2003 to Kim entitled Head Operated Computer Pointer is another example of this: it is mounted on the user's head.

U.S. Pat. No. 6,489,948 dated Dec. 3, 2002 to Lau entitled Computer Mouse Having Multiple Cursor Positioning Inputs and Method of Operation teaches a computer mouse having a trackball. It may have a joystick as well in the mouse. There is no provision for two units located at proper hand positions on either side of a keyboard.

U.S. Pat. No. 6,441,805 dated Aug. 27, 2002 to Reid et al entitled Ergonomic Computer Mouse is obviously related to human factors of hand comfort.

U.S. Pat. No. 6,342,009 dated Jan. 29, 2002 to Soma entitled Input Device for Game Machine is an example of something that exists in other forms as well: a single unit for use with two hands.

One family of devices which exist are those allowing two different “point and click” devices to be plugged into the same computer. While most personal computers have only a single dedicated mouse port, they normally also have several USB ports or various types of serial ports (RS-232, RS-232C, or other types of “legacy” ports) which allows more than one device to be plugged into the same computer. This is disadvantageous in that it requires the use of more than one port, and thus more than one software port within the machine operating system with concurrent increases in other computer resources such as processor cycles and memory. Furthermore, such devices as there are tend to be designed to be used as a supplement to an existing input device or to limit the potential placements of the two point and click devices by integrating the two devices into a standard keyboard, thus permanently fixing the physical relationship of the point, click, and keyboard command input devices. The latter can be extremely aggravating, for example to left-handed users, individuals with handicaps and so on.

U.S. Pat. No. 6,567,073 dated May 20, 2003 to Levin entitled Ambidextrous Computer Mouse, however, is an example of a human factor design which deals with two handed usage: a mouse which can be used with either hand. The purpose and concept, and thus the structure, is totally different from the present invention.

U.S. Pat. No. 6,025,830 dated Feb. 15, 2000 to Cohen entitled Game Controller for Infants is mostly of interest since it is a sort of second controller for input, but it is not a joystick, nor a mouse, nor does it seem to share a port with the mouse it is used with.

U.S. Pat. No. 5,838,305 dated Nov. 17, 1998 to Bookstein entitled Foot-Operated Control Mechanism for Computers is another ergonomics related device of little obvious relationship to the present invention.

U.S. Pat. No. 5,572,238 dated Nov. 5, 1996 to Krivacic entitled Computer User Interface for Non-Dominant Hand Assisted Control is of interest. It teaches a secondary pointing device, however apparently using two different ports for two pointing devices, so it seems to be different than the present invention.

U.S. Pat. No. 5,421,590 dated Jun. 6, 1995 to Robbins entitled Multiple Linked Game Controllers is of interest as it shows multiple joysticks entering one port of a game system. Since game systems are now safely removed from computer systems, this is different in art. Structurally, it also lacks provision of two units on each side of a keyboard (since it teaches away from keyboards), and does not teach separation of pointing and clicking structures onto separate modules. This is also designed so two players can play simultaneously and together.

It would be beneficial to provide a single device which would allow heavy computer users, for specific example users in the computer graphics arts fields, a more natural and less coordination intensive method of pointing and clicking with a two handed but single port device. Such a device should allow pointing functions to occur with a first hand and allow all the clicking actions to occur by use of the second hand. An alternative option is sending some click commands with the first hand by means of a button on the first hand's module, while allowing the majority of clicking actions to occur with a second hand.

It would further be beneficial to allow the actions with each hand located at its own convenient location on the work surface in front of the user.

### SUMMARY OF THE INVENTION

General Summary

A computer input device has two modules, each module located at the natural resting position of one of the computer user's corresponding hands on a work surface. The first module has a pointing device, while the second module has a touch sensitive device such as a button. By this means, users who spend a great deal of time on the computer may easily input analog data by using one hand to point and the other hand to click, thus splitting up the point and click effort between two hands. Connections may be established wirelessly.

Summary in Reference to Claims

It is therefore one aspect, advantage, objective and embodiment of the present invention to provide a computer pointing device for use on a work surface by a human user located facing the work surface, the pointing device comprising: a first module disposed at a first position corresponding to the natural rest position of such human user's first hand on such work surface; a second module disposed at a second position corresponding to the natural rest position of such human user's second hand on such work surface; the first and second modules being operatively electrically connected by a first cable having a first length; the first and second modules having a second cable having a second length, the second cable operatively electrically connecting the first and second modules to a first computer pointing device input port on such computer; the first module having a computer pointing device thereon; and the second module having a first touch sensitive device thereon.

It is therefore one aspect, advantage, objective and embodiment of the present invention to provide a computer pointing device wherein the cable first length is greater than the length of a standard computer keyboard.

It is therefore one aspect, advantage, objective and embodiment of the present invention to provide a computer pointing device wherein the first position is adjacent to a first end of a computer keyboard, and the second position is adjacent to a second end of the computer keyboard, and wherein the cable first length is greater than the length of the computer keyboard.

It is therefore one aspect, advantage, objective and embodiment of the present invention to provide a computer pointing device wherein the first module transmits to the computer standard signals associated with the pointing function of a standard mouse, and wherein the second module transmits to the computer standard signals associated with the clicking functions of a standard mouse.

It is therefore one aspect, advantage, objective and embodiment of the present invention to provide a computer pointing device wherein the first module comprises a base part and a manipulable part, and wherein pressure applied to the manipulable part generates standard signals associated with the pointing function of a standard mouse, and wherein the base part comprises a generally mouse-shaped housing.

It is therefore one aspect, advantage, objective and embodiment of the present invention to provide a computer pointing device wherein the first computer pointing device input port on such computer further comprises one member selected from the group consisting of: USB port, RS-232, RS-232 variant, large PS/2 mouse port, small PS/2 mouse port, Firewire, IEEE-1394, and other direct or indirect connections, connectors or ports of any now known or later-developed manner, style, type, specification.

It is therefore one aspect, advantage, objective and embodiment of the present invention to provide a computer pointing device wherein the connections are established with wireless devices.

It is therefore one aspect, advantage, objective and embodiment of the present invention to provide a computer pointing device wherein the computer pointing device further comprises one member selected from the group consisting of: a joystick, a mouse, a trackball, a touch pad, and a pressure sensitive pointing device.

It is therefore one aspect, advantage, objective and embodiment of the present invention to provide a computer pointing device an improved computer keyboard wherein the improvement comprises: a pointing device located at a first end of the keyboard, and a clicking device located at the distal second end of the keyboard.

It is therefore one aspect, advantage, objective and embodiment of the present invention to provide a computer pointing device wherein the pointing device is operatively connected to the keyboard by a cable.

It is therefore one aspect, advantage, objective and embodiment of the present invention to provide a computer pointing device wherein the clicking device is operatively connected to the keyboard by a cable.

It is therefore one aspect, advantage, objective and embodiment of the present invention to provide a computer pointing device wherein the clicking device is operatively connected to the keyboard by a wireless connection.

It is therefore one aspect, advantage, objective and embodiment of the present invention to provide a computer pointing device wherein the clicking device is operatively connected to the keyboard by a wireless connection.

It is therefore one aspect, advantage, objective and embodiment of the present invention to provide a computer pointing device for use on a work surface by a human user located facing the work surface, the pointing device comprising: a first module disposed at a first position corresponding to the natural rest position of such human user's first hand on such work surface; a second module disposed at a second position corresponding to the natural rest position of such human user's second hand on such work surface; the first and second modules having a wireless operative connection to a first computer wireless hub device operatively connected to such computer; the first module having a computer pointing device thereon; and the second module having a first touch sensitive device thereon.

It is therefore one aspect, advantage, objective and embodiment of the present invention to provide a computer pointing device wherein the computer pointing device further comprises one member selected from the group consisting of: a joystick, a mouse, a trackball, a touch pad, and a pressure sensitive pointing device of any now known or later-developed manner, style, type, specification.

### BRIEF DESCRIPTION OF THE DRAWINGS

FIG. 1 is a top view of the overall apparatus of the invention, according to a first preferred embodiment of the invention and not shown in the normal use position.

FIG. 2 is a front elevational view of the modules of the preferred embodiment of the invention disposed upon either side of a keyboard in the use position.

FIG. 3 is a front elevational view of the modules of a first alternative embodiment of the invention disposed upon either side of a keyboard in the use position.

FIG. 4 is a front elevational view of the modules of a second alternative embodiment of the invention disposed upon either side of a keyboard in the use position.

FIG. 5 is a front elevational view of the modules of a third alternative embodiment of the invention disposed upon either side of a keyboard in the use position.

FIG. 6 top view of the joystick module of the fourth alternative embodiment.

FIG. 7 top view of the joystick module of the fifth alternative embodiment.

FIG. 8 is a top view of the function pad module of the invention.

FIG. 9 is a top view of the function pad module of the invention according to a sixth alternative embodiment.

FIG. 10 is a side view of the joystick module of the seventh alternative embodiment of the invention.

### INDEX TO REFERENCE NUMERALS

2 Function Pad Module

4 Joystick Module

6a First Mouse Cable

6b Second Mouse Cable

6c Third Mouse Cable

8 Joystick

10 Joystick Module Bottom

14a First Touch Sensitive Device

16 Scroll Wheel

18 Wrist Support

24 Computer

28 Keyboard

40 Wireless hub

42 Wireless hub cable

52 Comfort Pad

56 Joystick button

### DETAILED DESCRIPTION

The term “computer pointing device” as used herein refers to such items as joysticks, mice, track balls, touch pads, pressure sensitive pointing devices of any now known or later-developed manner, style, type, specification.

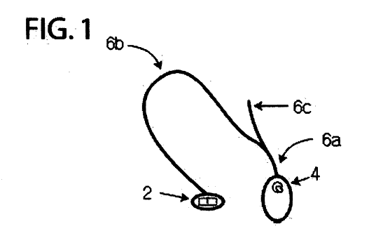

FIG. 1 is a top view of the overall apparatus of the invention, according to a first embodiment of the invention and not shown in the normal use position. In this presently preferred embodiment and best mode presently contemplated for carrying out the invention, function pad module 2 connects to joystick module 4 via first standard mouse cable 6a and second standard mouse cable 6b. Third mouse cable 6c connects the invention to a computer's pointing device input port. Such computer may be any type of computer on the market, regardless of type, operating system, power, processor or other qualities, so long as it uses such input devices as a computer mouse, a joystick, a touch pad, an embedded pointing device in the keyboard, etc. The first computer pointing device input port on such computer further comprises one member selected from the group consisting of: USB port, RS-232, RS-232 variant, large PS/2 mouse port, small PS/2 mouse port, Firewire, IEEE-1394, and other direct or indirect connections, connectors or ports of any now known or later-developed manner, style, type, specification.

The cable or cables connecting the two modules of the device may have a combined or individual length greater than the length of a standard computer keyboard, whether a PS/2 keyboard, 104 key keyboard, USB keyboard, etc. In general, this length will be in the range of 24 inches (approx 61 cm.) in order allow the two devices to be comfortably placed on either side of such a keyboard, with enough extra cable to allow a loose routing of the cable therebetween. As an alternative, a cordless connection could be used between the components and/or the computer, wireless alternative embodiments are discussed below.

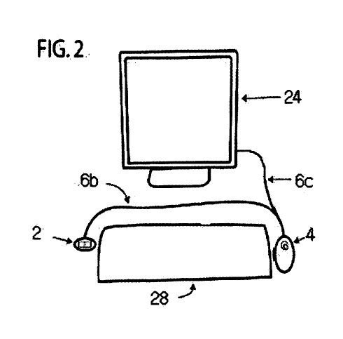

The modules are placed at two or more positions near the keyboard, as shown in FIGS. 2 through 5 in reference to various embodiments. The presently contemplated best mode of use of the invention is as follows. The first position is adjacent to a first end of a computer keyboard, and the second use position is adjacent to a second end of the computer keyboard, with the first module 4 disposed at the first position and the second module 2 disposed at a second position.

The first use position corresponds to the natural rest position of such human user's first hand on such work surface and the second use position corresponds to the natural rest position of such human user's second hand on such work surface. Obviously, the user may somewhat adjust the exact placement of the device in and at these general positions.

The modules 2 and 4 combine to act as a standard mouse or joystick. The first module 4 transmits to the computer standard signals associated with the pointing function of a standard mouse, while the second module 2 transmits to the computer standard signals associated with the clicking functions of a standard mouse. In alternative embodiments having a scroll wheel, the scrolling functions of the mouse are generated in the pad module 2.

Standard and well known cursor control software may be used to customize cursor acceleration, speed, blink rate, automate clicking functions, allow for Mouse Gesture programming and so on.

FIG. 2 is a front elevational view of the modules of the preferred embodiment of the invention disposed upon either side of a keyboard in the use position. Second cable 6b is long enough to connect joystick module 4 and second module 2, while first and third cables 6a and 6c connect the modules directly to the computer. Both modules are shown disposed at ends of the keyboard.

In alternative usage embodiments of the invention, the two modules may be placed at ANY convenient location within reach of the cables, and for this reason it is desirable that the various cables of the invention be of at least a reasonable length such as 24 inches each. For some users, reversing the placement shown may be necessary, while for others placing one or both modules at dramatically different locations may be beneficial.

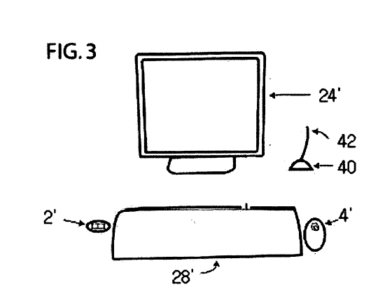

FIG. 3 is a front elevational view of the modules of a first alternative embodiment of the invention disposed upon either side of a keyboard in the use position. This is a wireless embodiment in which second module 2′ and first module 4′ are connected by wireless signals to wireless hub 40 having cable 42 and thence to computer 24′. Keyboard 28′ may also be wireless in design. The usage and construction of such devices is known: they may be RF, RF with Bluetooth or similar protocols, IR and combinations thereof.

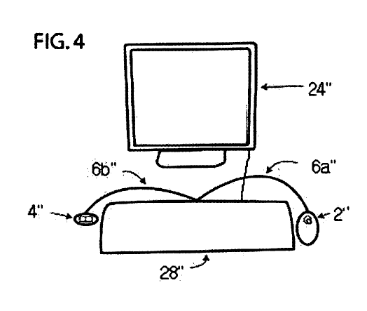

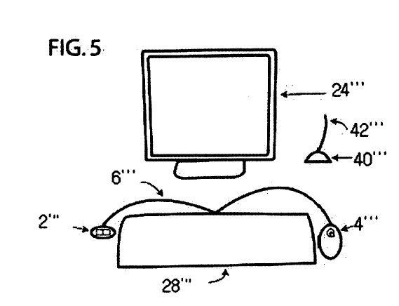

FIG. 4 is a front elevational view of the modules of a second alternative embodiment of the invention disposed upon either side of a keyboard in the use position. In this embodiment, modules 2″ and 4″ connect to keyboard 28″ and thence to the computer, thus eliminating cable 6c. FIG. 5 is a front elevational view of the modules of a third alternative embodiment of the invention disposed upon either side of a keyboard in the use position. This combinational embodiment relies upon a wireless keyboard 28′″ to connect to wireless hub/cable 40′″/42′″ and thence to computer 24′″, but without requiring wireless capabilities of modules 2′″ and 4′″: these modules may connect via cable 6′″ to the keyboard 28′″.

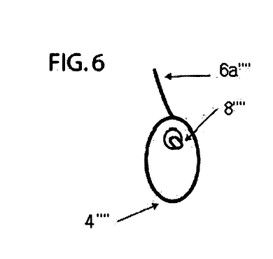

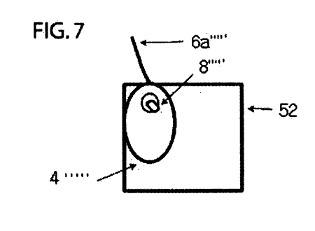

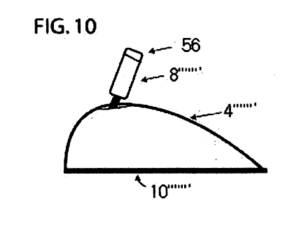

FIG. 6 is a top view of the joystick module of the fourth alternative embodiment. FIG. 7 top view of the joystick module of the fifth alternative embodiment. FIG. 10 is a side view of the joystick module of the seventh alternative embodiment of the invention. The difference is that an optional button used in the seventh alternative embodiment may be positioned upon the joystick (8″″″). (“Prime” marks (8″″) indicating the numeration of the appropriate alternative embodiment for repeated components. In general terms a component “8” may refer to that same component regardless of which embodiment is referred to. Specific differences are pointed out by textual reference to the appropriate reference numeral with prime marks.)

The embodiment of FIG. 6 shows that the joystick may function as a large button, so when grasped like a pencil and pushed down, the entire joystick provides the button action.

The embodiment of FIG. 7 shows a comfort pad 52 which may support the wrist of the user in a manner analogous to the wrist support 18 used with the click function module 2.

Generally for all embodiments, joystick module 4 generally comprises joystick 8 and joystick module bottom 10. Contained within either module may be circuitry (not shown) which may carry out normal functions in accepting pressure applied to the manipulable part and generating therefrom standard signals associated with computer cursor pointing functions, computer graphics functions, game play functions and so on, that is, it functions in a manner identical to the pointing functions of a standard mouse or joystick, regardless of details of the internal mechanisms used to generate such signals (i.e. the difference between pressure sensing, switch sensors, optical sensors and so on is not claimed herein).

The first module 4 comprises a base part 10 and a manipulable part 8, and in the best mode presently contemplated, the base part comprises a generally mouse-shaped housing. The advantages of a mouse shaped housing include ease of recognition by users, convenient and ergonomic size and shape, an absence of sharp edges and others. There may be a bottom having a soft rubber manufacture, or small feet, or other devices to assist in maintaining placement of the device in the desired position. The joystick device may be grasped like a pen or pencil and an optional click command can be sent by depressing the joystick itself or by means of a button somewhere on the component, an example being the top of the joystick as shown in FIG. 10.

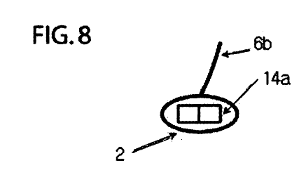

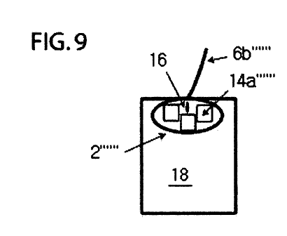

FIG. 8 is a top view of the function pad module of the invention according to the preferred embodiment and best mode now contemplated while FIG. 9 is a top view of the function pad module of the invention according to a sixth alternative embodiment. First, second, third and fourth touch sensitive devices such as first touch sensitive device 14a may conveniently be visualized as buttons and are in alternative embodiments, however, in the presently preferred embodiments these are not actual physical switches but rather touch sensitive devices such as body capacitance sensors or the like.

Wrist support 18 may provide more ergonomic benefit by supporting the user's wrist and hand in the proper orientation on pad module 2″″″. Standard scroll wheel 16 is presently placed in the sixth alternative embodiment depicted herein on function pad module 2″″″. However, in alternative preferred embodiments, it may be located on the first module 4 (the joystick module). Scroll wheels have become an increasingly common feature of modern computer mice and provide another ergonomic benefit thereto. A normal scroll wheel allows vertical motion of a “scroll bar” type device in the vertical plane of the computer display, or may provide game functionality, graphical functionality and so on, normally in the vertical plane. However, while scroll wheels are often used for scrolling a graphical display, they are also quite frequently used to scroll down a list and may also have “click” generation functionality built into the wheel itself, and thus partake of both pointing and clicking. At the present stage of testing, it has been determined that placement on the second module (the function pad module 2) is simply easier to learn and use.

Touching or pushing any of the touch sensitive areas generates standard mouse click commands such as single click, double click, click drags, right clicks, cut and paste and so on.

This disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying this application.

I claim:

1. A computer pointing device for use on a work surface by a human user located facing the work surface, the pointing device comprising:
a first module disposed at a first position corresponding to the natural rest position of such human user's first hand on such work surface;
a second module disposed at a second position corresponding to the natural rest position of such human user's second hand on such work surface;
the first and second modules being operatively electrically connected by a first cable having a first length;
the first and second modules having a second cable having a second length, the second cable operatively electrically connecting the first and second modules to a first computer pointing device input port on such computer;
the first module having a computer pointing device thereon; and
the second module having a first touch sensitive device thereon.

2. The pointing device of claim 1, wherein the cable first length is greater than the length of a standard computer keyboard.

3. The pointing device of claim 1, wherein the first position is adjacent to a first end of a computer keyboard, and the second position is adjacent to a second end of the computer keyboard, and wherein the cable first length is greater than the length of the computer keyboard.

4. The pointing device of claim 1, wherein the first module transmits to the computer standard signals associated with the pointing function of a standard mouse, and wherein the second module transmits to the computer standard signals associated with the clicking functions of a standard mouse.

5. The pointing device of claim 1, wherein the first module comprises a base part and a manipulable part, and wherein pressure applied to the manipulable part generates standard signals associated with the pointing function of a standard mouse, and wherein the base part comprises a generally mouse-shaped housing.

6. The pointing device of claim 1, wherein the first computer pointing device input port on such computer further comprises one member selected from the group consisting of: USB port, RS-232, RS-232 variant, large PS/2 mouse port, small PS/2 mouse port, Firewire, IEEE-1394, and combinations thereof.

7. The pointing device of claim 1, wherein the first module base part further comprises:
a first scroll wheel.

8. The pointing device of claim 1, wherein the second module base part further comprises:
a first scroll wheel.

9. The pointing device of claim 1, wherein the second module further comprises a wrist support.

10. The pointing device of claim 1, wherein the computer pointing device further comprises one member selected from the group consisting of: a joystick, a mouse, a trackball, a touch pad, and a pressure sensitive pointing device.

11. An improved computer keyboard wherein the improvement comprises:
a pointing device located at a first end of the keyboard, and
a clicking device located at the distal second end of the keyboard.

12. The device of claim 11, wherein the pointing device is operatively connected to the keyboard by a cable.

13. The device of claim 11, wherein the clicking device is operatively connected to the keyboard by a cable.

14. The device of claim 11, wherein the pointing device is operatively connected to the keyboard by a wireless connection.

15. The device of claim 11, wherein the clicking device is operatively connected to the keyboard by a wireless connection.

16. A computer pointing device for use on a work surface by a human user located facing the work surface, the pointing device comprising:
a first module disposed at a first position corresponding to the natural rest position of such human user's first hand on such work surface;
a second module disposed at a second position corresponding to the natural rest position of such human user's second hand on such work surface;
the first and second modules having a wireless operative connection to a first computer wireless hub device operatively connected to such computer;
the first module having a computer pointing device thereon; and
the second module having a first touch sensitive device thereon.

17. The pointing device of claim 16, wherein the computer pointing device further comprises one member selected from the group consisting of: a joystick, a mouse, a trackball, a touch pad, and a pressure sensitive pointing device.
